(19) United States
(12) Patent Application Publication
(10) Pub. No.: US 2026/0204661 A1
(43) Pub. Date: Jul. 16, 2026

(54) SOLID-STATE ELECTROLYTE MATERIAL, ELECTRODE, AND SOLID-STATE BATTERY

(71) Applicant: Murata Manufacturing Co., Ltd., Nagaokakyo-shi (JP)

(72) Inventors: Yusuke MORINO, Nagaokakyo-shi (JP); Hiroki MITA, Nagaokakyo-shi (JP); Daisuke ITO, Nagaokakyo-shi (JP)

(21) Appl. No.: 19/564,911

(22) Filed: Mar. 12, 2026

Related U.S. Application Data
(63) Continuation of application No. PCT/JP2024/021474, filed on Jun. 13, 2024.

(30) Foreign Application Priority Data
Sep. 20, 2023 (JP) 2023-152165

(51) Int. Cl. H01M 10/42; H01M 10/0525; H01M 10/054; H01M 10/0562

(52) U.S. Cl. CPC H01M 10/4235; H01M 10/0525; H01M 10/054; H01M 10/0562; H01M 2300/008; H01M 2300/0094

(57) ABSTRACT

A solid-state electrolyte material that includes: a solid-state electrolyte particle; and a covering part on a surface of the solid-state electrolyte particle, the covering part including Li₂₊ₓ(OH)₁₋ₓY, where 0≤x<1, and Y is chlorine, bromine, or iodine.

### CROSS REFERENCE TO RELATED APPLICATIONS

The present application is a continuation of International application No. PCT/JP2024/021474, filed Jun. 13, 2024, which claims priority to Japanese Patent Application No. 2023-152165, filed Sep. 20, 2023, the entire contents of each of which are incorporated herein by reference.

### TECHNICAL FIELD

The disclosure relates to a solid-state electrolyte material, an electrode including the solid-state electrolyte material, and a solid-state battery including the solid-state electrolyte material.

### BACKGROUND ART

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member.

Recently, a solid-state battery has been developed. The solid-state battery is a secondary battery that includes a solid-state electrolyte instead of a liquid or gel electrolyte including a solvent such as an organic solvent. For example, PTL 1 below proposes a sulfide solid-state electrolyte material that allows for improvement in a charge and discharge characteristic of a battery. In addition, PTL 2 below proposes a solid-state electrolyte composite particle that includes a solid-state electrolyte having a low grain boundary resistance, a superior ion conductivity, and a high denseness.

PTL 1: Japanese Unexamined Patent Application Publication No. 2018-026321 PTL 2: Japanese Unexamined Patent Application Publication No. 2021-77463

### SUMMARY OF THE DISCLOSURE

As described in the prior art documents above, consideration has been given in various ways to improve performance of a solid-state battery. However, there is still room for improvement in the performance of the solid-state battery.

It is therefore desirable to provide a solid-state battery having superior performance, a solid-state electrolyte material to be included in the solid-state battery, and an electrode to be included in the solid-state battery.

A solid-state electrolyte material according to one embodiment of the disclosure includes: a solid-state electrolyte particle; and a covering part on a surface of the solid-state electrolyte particle, the covering part including Li₂₊ₓ(OH)₁₋ₓY, where 0≤x<1, and Y is chlorine, bromine, or iodine.

The solid-state electrolyte material according to one embodiment of the disclosure includes the covering part provided on the surface of the solid-state electrolyte particle. This allows the solid-state electrolyte particle to be protected from, for example, air or moisture. Therefore, for example, even when the solid-state electrolyte particle includes a sulfide, it is possible to suppress generation of hydrogen sulfide. The covering part includes Li₂₊ₓ(OH)₁₋ₓY, where 0≤x<1, and Y is chlorine, bromine, or iodine. This prevents a decrease in ion conductivity. As a result, it is possible to achieve superior performance.

Note that effects of the disclosure are not necessarily limited to those described above and may include any of a series of effects described below in relation to the disclosure.

### BRIEF DESCRIPTION OF THE DRAWINGS

FIG. 1 is a schematic sectional diagram illustrating a configuration example of a solid-state electrolyte material according to one embodiment of the disclosure.

FIG. 2 is a schematic sectional diagram illustrating a configuration example of a solid-state battery including the solid-state electrolyte material illustrated in FIG. 1.

FIG. 3 is an enlarged schematic sectional diagram illustrating a part of a positive electrode active material layer of the solid-state battery illustrated in FIG. 2.

### DESCRIPTION OF THE PREFERRED EMBODIMENTS

Some embodiments of the disclosure are described below in detail with reference to the drawings. The description is given in the following order.
0. Outline of Disclosure
1. First Embodiment
1.1 Configuration of Solid-State Electrolyte Material
1.2 Method of Manufacturing Solid-State Electrolyte Material
1.3 Action and Effects of Solid-State Electrolyte Material
2. Second Embodiment
2.1 Configuration of Solid-State Battery
2.2 Method of Manufacturing Solid-State Battery
2.3 Action and Effects of Solid-State Battery
3. Examples

Note that a “solid-state battery” of the disclosure refers to a battery whose components are solids. The “solid-state battery” of the disclosure is, for example, a stacked-type solid-state battery including a stack of a plurality of layers. The layers each include, for example, a sintered body. The “solid-state battery” of the disclosure encompasses not only a secondary battery that is repeatedly chargeable and dischargeable, but also a primary battery that is only dischargeable.

### 0. OUTLINE OF DISCLOSURE

First, an outline of the disclosure is described.

Consideration has been given in various ways to improve performance of a solid-state battery. The solid-state battery includes a solid-state electrolyte, and is thus typically superior in tolerance to high temperature and higher in safety, as compared with a battery including a liquid electrolyte. More specifically, the solid-state battery does not need to include a flammable solvent included in the liquid electrolyte, and is thus prevented from catching a fire, as compared to the battery including the liquid electrolyte. In addition, the solid-state battery allows for suppression of volume expansion of the battery, which is to be caused by decomposition of the liquid electrolyte. The solid-state battery is thus expected to have a longer life.

One of attention-catching materials to be included in such a solid-state electrolyte that influences the performance of the solid-state battery is a solid-state electrolyte material including a sulfide. The solid-state electrolyte material including the sulfide has a high ion conductivity at room temperature, does not require a high-temperature sintering process, and is thus processable at low temperature. However, such a sulfide solid-state electrolyte material can generate hydrogen sulfide by reacting with moisture in atmospheric air, for example.

To suppress such generation of hydrogen sulfide, for example, PTL 1 proposes a sulfide solid-state electrolyte material in which an oxide layer including an oxide of a sulfide material is provided on a surface of a sulfide solid-state electrolyte particle. Specifically, PTL 1 reports a technique regarding surface treatment that substitutes one or more sulfur (S) atoms on the surface of the sulfide solid-state electrolyte particle with one or more oxygen (O) atoms. However, according to the technique of PTL 1, it seems to be difficult to sufficiently suppress generation of hydrogen sulfide from the sulfide solid-state electrolyte particle, when only a small number of sulfur atoms on the surface of the sulfide solid-state electrolyte particle are substituted with the oxygen atoms. In addition, when a lot of sulfur atoms on the surface of the sulfide solid-state electrolyte particle are substituted with the oxygen atoms, the ion conductivity can decrease due to an increase in amount of an oxide on the surface of the sulfide solid-state electrolyte particle. There is also a concern that original flexibility of the sulfide solid-state electrolyte particle can be degraded, which can result in degradation of bonding between the sulfide solid-state electrolyte particles or in degradation of formability of the sulfide solid-state electrolyte material.

In addition, PTL 2 proposes a solid-state electrolyte composite particle in which a surface of a mother particle is covered with a coating layer. Examples of the coating layer mentioned in PTL 2 include an oxo acid compound (LiNbO₃) or a lithium salt (such as LiCl, LiBr, LiI, or LiOH). However, when the coating layer is the oxo acid compound, bonding between the solid-state electrolyte composite particles is degraded due to poor flexibility of the coating layer. In addition, because halogenated lithium and lithium hydroxide are non-conductive, using such a material decreases lithium ion conductivity of the coating layer. This can decrease ion conductivity of an interface between the solid-state electrolyte composite particles.

In view of such circumstances, the Applicant proposes below a solid-state battery having superior performance, a solid-state electrolyte material to be included in the solid-state battery, and an electrode to be included in the solid-state battery.

### 1. FIRST EMBODIMENT

### <1.1 Configuration of Solid-State Electrolyte Material SE>

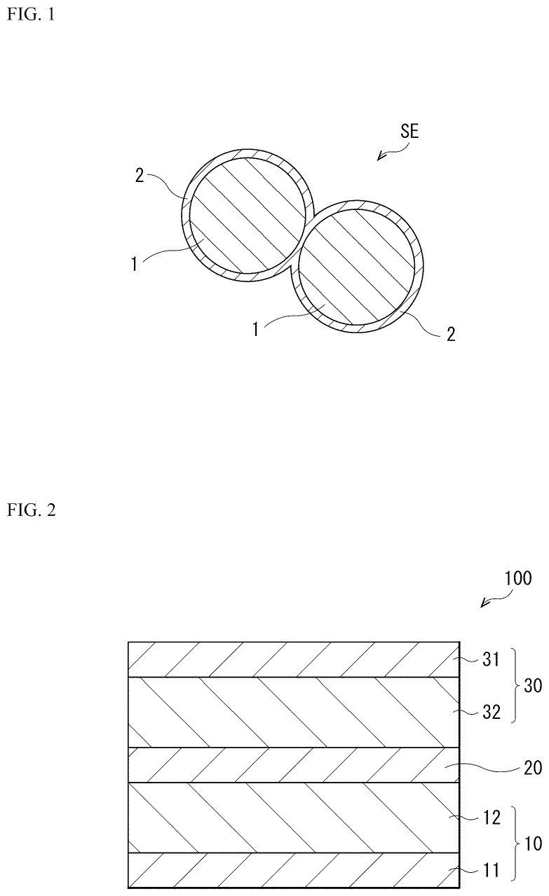

Referring to FIG. 1, a description is given below of a configuration of a solid-state electrolyte material SE according to an embodiment of the disclosure. FIG. 1 is a schematic sectional diagram schematically illustrating a configuration example of the solid-state electrolyte material SE. The solid-state electrolyte material SE includes a solid-state electrolyte particle 1 and a covering part 2. The covering part 2 is provided on a surface of the solid-state electrolyte particle 1. The solid-state electrolyte material SE includes a plurality of solid-state electrolyte particles 1. The covering part 2 is provided to cover the surface of each of the solid-state electrolyte particles 1. As illustrated in FIG. 1, the covering parts 2 covering the respective solid-state electrolyte particles 1 adjacent to each other may be coupled to each other to be one part. Note that FIG. 1 illustrates, for convenience, a state in which the covering parts 2 cover the entire surfaces of the solid-state electrolyte particles 1; however, the covering parts 2 may have a void or an opening in part. In other words, it suffices that the covering parts 2 are each so provided as to cover at least a part of the surface of corresponding one of the solid-state electrolyte particles 1.

### <Solid-State Electrolyte Particle 1>

The solid-state electrolyte particle 1 is, for example, a particle of a solid-state electrolyte that is configured to conduct an ion such as a lithium ion or a sodium ion. Examples of the solid-state electrolyte included in the solid-state electrolyte particle 1 include a lithium-containing phosphoric acid compound having a NASICON structure, an oxide having a perovskite structure, and an oxide having a garnet structure or a garnet-like structure. Examples of the lithium-containing phosphoric acid compound having the NASICON structure include LiₓM_{y}(PO₄)₃(1≤x≤2, 1≤y≤2, and M is at least one selected from the group consisting of Ti, Ge, Al, Ga, and Zr). Examples of the lithium-containing phosphoric acid compound having the NASICON structure include Li_{1.2}Al_{0.2}Ti_{1.8}(PO₄)₃. Examples of the oxide having the perovskite structure include La_{0.55}Li_{0.35}TiO₃. Examples of the oxide having the garnet structure or the garnet-like structure include Li₇La₃Zr₂O₁₂. Further, examples of the solid-state electrolyte that is configured to conduct a sodium ion include a sodium-containing phosphoric acid compound having a NASICON structure, an oxide having a perovskite structure, and an oxide having a garnet structure or a garnet-like structure. Examples of the sodium-containing phosphoric acid compound having the NASICON structure include NaₓM_{y}(PO₄)₃(1≤x≤2, 1≤y≤2, and M is at least one selected from the group consisting of Ti, Ge, Al, Ga, and Zr).

The solid-state electrolyte particle 1 may be a particle of a sulfide solid-state electrolyte including a sulfide. The sulfide solid-state electrolyte included in the solid-state electrolyte particle 1 may be a lithium salt including sulfur (S) represented by Li-M-S(where M is, for example, at least one of phosphorous (P), tin (Sn), germanium (Ge), or silicon (Si)). The sulfide solid-state electrolyte included in the solid-state electrolyte particle 1 may be a lithium salt further including a halogen element represented by Li-M-S-X (where M is, for example, at least one of phosphorous (P), tin (Sn), germanium (Ge), or silicon (Si), and X is, for example, at least one of chlorine (Cl), fluorine (F), bromine (Br), or iodine (I)). Specific examples of the sulfide solid-state electrolyte include Li₆PS₅Cl, Li₆PS₅Cl_{0.5}Br_{0.5}, Li₄SnS₄, and Li_{4.5}SnS₄I_{0.5}. In addition, the sulfide solid-state electrolyte may be Li₇PS₆ having an argyrodite structure, a partially substituted material of Li₇PS₆ having the argyrodite structure, Li₁₀GeP₂Si₂ having a LISICON structure, a partially substituted material of Li₁₀GeP₂Si₂ having the LISICON structure. Examples of the partially substituted material of Li₇PS₆ having the argyrodite structure include Li₆PS₅Cl and Li₆PS₅Br. Examples of the partially substituted material of Li₁₀GeP₂Si₂ having the LISICON structure include Li₁₀SiP₂Si₂ and Li_{9.54}Si_{1.74}P_{1.44}S_{11.7}Cl_{0.3}.

Note that the solid-state electrolyte particle 1 may include two or more of the above-described constituent materials. In addition, the solid-state electrolyte particle 1 may have a median diameter of, for example, 0.1 μm to 20 μm.

### <Covering Part 2>

The covering part 2 is provided on the surface of the solid-state electrolyte particle 1, and includes Li₂₊ₓ(OH)₁₋ₓY where x satisfies 0≤x<1, and Y is chlorine (Cl), bromine (Br), or iodine (I). The covering part 2 has a thickness of, for example, 1 nm to 1000 nm. When the thickness of the covering part 2 is less than 1 nm, it is difficult to sufficiently protect the solid-state electrolyte particle 1 from, for example, air or moisture.

An OH group included in the covering part 2 attached to the surface of the solid-state electrolyte particle 1 is detectable by performing, for example, a diffuse reflectance infrared (IR) spectroscopy analysis or a Raman spectroscopy analysis on the solid-state electrolyte material SE of the present embodiment. Further, Li₂₊ₓ(OH)₁₋ₓY is identifiable by performing an X-ray diffractometry (XRD) analysis on the covering part 2. Further, respective compositions of the solid-state electrolyte particle 1 and the covering part 2 are analyzable by energy dispersive X-ray spectroscopy such as transmission electron microscopy energy dispersive X-ray spectroscopy (TEM-EDX).

### <1.2 Method of Manufacturing Solid-State Electrolyte Material SE>

Next, a description is given of an example of a method of manufacturing the solid-state electrolyte material SE according to the present embodiment.

<1.2.1>

First, the solid-state electrolyte particle 1 having a predetermined median diameter is prepared. When the solid-state electrolyte particle 1 includes the solid-state electrolyte including chlorine (Cl), bromine (Br), or iodine (I), the solid-state electrolyte particle 1 is put into an electric furnace, and a nitrogen (N₂) gas or an argon (Ar) gas controlled to have a dew point within a range from −60° C. to −40° C. both inclusive is injected into the electric furnace for one hour, following which the solid-state electrolyte particle 1 is heated at temperature of 150° C. for one hour in the atmosphere of the nitrogen (N₂) gas or the argon (Ar) gas. Thus, the covering part 2 including Li₂₊ₓ(OH)₁₋ₓY (where x 0≤x<1, and Y is chlorine (Cl), bromine (Br), or iodine (I)) is formed on the surface of the solid-state electrolyte particle 1. As a result, the solid-state electrolyte material SE according to the present embodiment is obtained.

<1.2.2>

When the solid-state electrolyte particle 1 does not include any of chlorine (Cl), bromine (Br), or iodine (I), or when the covering part 2 is formed that includes a halogen element different from a halogen element which the solid-state electrolyte particle 1 includes, the solid-state electrolyte material SE is manufacturable by the following procedure. First, the solid-state electrolyte particle 1 having a predetermined median diameter is prepared, following which LiY (where Y is chlorine (Cl), bromine (Br), or iodine (I)) is added to the surface of the solid-state electrolyte particle 1 by mechanical milling or solution spraying. Thereafter, the covering part 2 including Li₂₊ₓ(OH)₁₋ₓY (where x 0≤x<1, and Y is chlorine (Cl), bromine (Br), or iodine (I)) is formed on the surface of the solid-state electrolyte particle 1 by performing a process similar to that in the above-described procedure in <1.2.1>. As a result, the solid-state electrolyte material SE according to the present embodiment is obtained.

<1.2.3>

When the solid-state electrolyte particle 1 does not include any of chlorine (Cl), bromine (Br), or iodine (I), or when the covering part 2 is formed that includes a halogen element different from the halogen element which the solid-state electrolyte particle 1 includes, the solid-state electrolyte material SE is manufacturable by the following procedure. First, LiY (where Y is chlorine (Cl), bromine (Br), or I (iodine)) and LiOH are mixed with each other to obtain a mixture, following which the mixture is subjected to a heating process and synthesized to obtain Li₂₊ₓ(OH)₁₋ₓY. Thereafter, Li₂₊ₓ(OH)₁₋ₓY obtained by the synthesis is added to the surface of the solid-state electrolyte particle 1 by the mechanical milling or the solution spraying. Thereafter, the covering part 2 including Li₂₊ₓ(OH)₁₋ₓY (where x 0≤x<1, and where Y is chlorine (Cl), bromine (Br), or iodine (I)) is formed on the surface of the solid-state electrolyte particle 1 by performing a process similar to that in the above-described procedure in <1.2.1>. As a result, the solid-state electrolyte material SE according to the present embodiment is obtained.

### <1.3 Action and Effects of Solid-State Electrolyte Material SE>

In the solid-state electrolyte material SE according to the present embodiment, the covering part 2 is provided on the surface of the solid-state electrolyte particle 1. This protects the solid-state electrolyte particle 1 from, for example, air or moisture, and thus improves environmental tolerance of the solid-state electrolyte particle 1. Accordingly, for example, even when the solid-state electrolyte particle 1 includes the sulfide solid-state electrolyte including the sulfide, it is possible to suppress generation of hydrogen sulfide (H₂S) caused by a reaction between sulfur and hydrogen. In addition, when the solid-state electrolyte particle 1 includes the sulfide solid-state electrolyte, it is possible to manufacture the solid-state electrolyte material SE at room temperature, without performing a high-temperature sintering process. It is also possible to achieve a high ion conductivity. In particular, in the solid-state electrolyte material according to the present embodiment, the covering part 2 includes Li₂₊ₓ(OH)₁₋ₓY (where x 0≤x<1, and Y is chlorine, bromine, or iodine). This makes it possible to suppress a decrease in ion conductivity of the solid-state electrolyte material caused by the presence of the covering part 2. In addition, because of including Li₂₊ₓ(OH)₁₋ₓY (where x 0<x<1, and Y is chlorine, bromine, or iodine), the covering part 2 has superior flexibility.

As described above, according to the solid-state electrolyte material SE of the present embodiment, it is possible to achieve superior performance. For example, it is possible to achieve both superior ion conductivity and superior processability.

Further, also when the solid-state electrolyte material SE according to the present embodiment is applied to the solid-state battery, the presence of the covering part 2 prevents, for example, contact between a material such as lithium cobalt oxide (LCO) as a positive electrode material or LTO as a negative electrode material and the sulfide solid-state electrolyte included in the solid-state electrolyte particle 1, and thus makes it possible to avoid decomposition of the sulfide solid-state electrolyte included in the solid-state electrolyte particle 1. Therefore, the solid-state electrolyte material SE according to the embodiment of the disclosure is favorable as a constituent material of the solid-state battery.

### 2. SECOND EMBODIMENT

### <1.1 Configuration of Solid-State Battery 100>

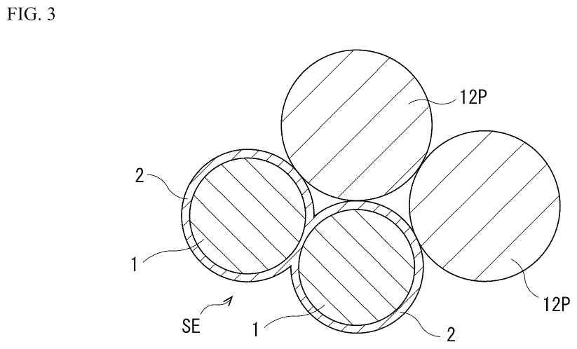

Referring to FIG. 2, a description is given of a configuration of a solid-state battery 100 according to an embodiment of the disclosure. FIG. 2 is a schematic sectional diagram schematically illustrating the configuration of the solid-state battery 100. The solid-state battery 100 has a stacked structure in which a positive electrode 10, a solid-state electrolyte layer 20, and a negative electrode 30 are stacked on each other in order. The negative electrode 30 includes a negative electrode current collector 31 and a negative electrode active material layer 32. Where a unit including the positive electrode 10, the solid-state electrolyte layer 20, and the negative electrode 30 that are stacked in order serves as a single unit, the solid-state battery 100 may have a structure in which multiple units are stacked on each other.

### <Positive Electrode 10>

The positive electrode 10 includes an electrode layer including at least a positive electrode active material. The positive electrode 10 includes a positive electrode current collector 11 and a positive electrode active material layer 12.

The positive electrode current collector 11 is, for example, a metal foil. The positive electrode current collector 11 includes, for example, one metal (a simple substance of a metal) selected from the group consisting of aluminum (Al), copper (Cu), magnesium (Mg), titanium (Ti), iron (Fe), cobalt (Co), nickel (Ni), zinc (Zn), germanium (Ge), indium (In), gold (Au), platinum (Pt), silver (Ag), and palladium (Pd), or an alloy including two or more metal elements selected from the group described above. Further, the positive electrode current collector 11 may be a sintered body. This is to allow the solid-state battery 100 to be formed by integral firing, or to reduce an internal resistance of the positive electrode current collector 11. When the positive electrode current collector 11 is the sintered body, the positive electrode current collector 11 may include a conductive additive and a sintering aid.

The positive electrode current collector 11 may have, for example, a shape such as a plate shape, a foil shape, or a mesh shape. The positive electrode current collector 11 may have a smooth surface, or may have a surface with asperities.

### <Positive Electrode Active Material Layer 12>

The positive electrode active material layer 12 includes a positive electrode active material as a major component. The positive electrode active material included in the positive electrode active material layer 12 contributes to insertion and extraction of an ion in the solid-state battery 100 and also contributes to supplying and receiving of an electron to and from an external circuit. The ion migrates between the positive electrode 10 and the negative electrode 30 via the solid-state electrolyte. In other words, ion conduction occurs between the positive electrode 10 and the negative electrode 30 via the solid-state electrolyte. The insertion and extraction of the ion into and from the positive electrode active material involve reduction and oxidation of the positive electrode active material. An electron or a hole for such oxidation and reduction reactions is supplied to the positive electrode 10 or the negative electrode 30, which allows charging and discharging to proceed. The positive electrode active material layer 12 is, for example, a layer which a lithium ion, a sodium ion, a proton (H⁺), a potassium ion (K⁺), a magnesium ion (Mg²⁺), an aluminum ion (Al³⁺), a silver ion (Ag⁺), a fluoride ion (F⁻), or a chloride ion (Cl⁻) is insertable into and extractable from. That is, the solid-state battery 100 is an all-solid-state secondary battery that is to be charged and discharged by the above-described ion migrating between the positive electrode 10 and the negative electrode 30 via the solid-state electrolyte.

### <Positive Electrode Active Material>

The positive electrode active material included in the positive electrode 10 includes, for example, at least one selected from the group consisting of, for example, a lithium-containing phosphoric acid compound having a NASICON structure, a lithium-containing phosphoric acid compound having an olivine structure, a lithium-containing layered oxide, and a lithium-containing oxide having a spinel structure. Examples of the lithium-containing phosphoric acid compound having the NASICON structure include Li₃V₂(PO₄)₃. Examples of the lithium-containing phosphoric acid compound having the olivine structure include Li₃Fe₂(PO₄)₃, LiFePO₄, LiMnPO₄, and LiFe_{0.6}Mn_{0.4}PO₄. Examples of the lithium-containing layered oxide include LiCoO₂, LiCo_{1/3}Ni_{1/3}Mn_{1/3}O₂, and LiCo_{0.5}Ni_{0.15}Al_{0.5}O₂. Examples of the lithium-containing oxide having the spinel structure include LiMn₂O₄ and LiNi_{0.5}Mn_{1.5}O₄.

The positive electrode active material which a sodium ion is insertable into and extractable from includes, for example, at least one selected from the group consisting of, for example, a sodium-containing phosphoric acid compound having a NASICON structure, a sodium-containing phosphoric acid compound having an olivine structure, a sodium-containing layered oxide, and a sodium-containing oxide having a spinel structure.

The positive electrode active material layer 12 includes the solid-state electrolyte material SE described in the first embodiment above. FIG. 2 is a schematic sectional diagram schematically illustrating a positive electrode active material particle 12P and the solid-state electrolyte material SE included in the positive electrode active material layer 12 in the positive electrode 10. The positive electrode active material particle 12P is a particle including the above-described positive electrode active material, and is partially in contact with the solid-state electrolyte material SE. That is, the positive electrode active material particle 12P is in contact with the covering part 2. In addition, a part of the solid-state electrolyte material SE may be in contact with the positive electrode current collector 11 in the vicinity of an interface between the positive electrode active material layer 12 and the positive electrode current collector 11. The solid-state electrolyte material SE has a plurality of voids.

### <Solid-State Electrolyte Layer 20>

The solid-state electrolyte layer 20 includes the solid-state electrolyte material SE described in the first embodiment above. The solid-state electrolyte material SE is a material that is configured to conduct an ion such as a lithium ion between the positive electrode 10 and the negative electrode 30.

### <Negative Electrode 30>

The negative electrode 30 is an electrode layer including at least a negative electrode active material. The negative electrode 30 includes the negative electrode current collector 31 and the negative electrode active material layer 32. The negative electrode current collector 31 is, for example, a metal foil such as a copper foil. Further, the negative electrode current collector 31 may be a sintered body. This is to reduce an internal resistance of the negative electrode current collector 31. When the negative electrode current collector 31 is the sintered body, the negative electrode current collector 31 may include a conductive additive and a sintering aid. The negative electrode active material layer 32 includes a negative electrode active material as a major component. The negative electrode active material will be described in detail later. The negative electrode active material layer 32 may further include the solid-state electrolyte material SE described in the first embodiment above. The negative electrode active material layer 32 includes a plurality of negative electrode active material particles each including the negative electrode active material. Each of the negative electrode active material particles is partially in contact with the solid-state electrolyte material SE.

### <Negative Electrode Active Material>

As with the positive electrode active material included in the positive electrode 10, the negative electrode active material included in the negative electrode 30 contributes to insertion and extraction of an ion in the solid-state battery 100 and also contributes to supplying and receiving of an electron to and from an external circuit. The ion migrates between the positive electrode 10 and the negative electrode 30 via the solid-state electrolyte layer 20. In other words, ion conduction occurs between the positive electrode 10 and the negative electrode 30 via the solid-state electrolyte layer 20. The insertion and extraction of the ion into and from the negative electrode active material involve oxidation and reduction of the negative electrode active material. An electron or a hole for such oxidation and reduction reactions is supplied to the positive electrode 10 or the negative electrode 30, which allows charging and discharging to proceed. The negative electrode active material is, for example, a material which a lithium ion, a sodium ion, a proton (H⁺), a potassium ion (K⁺), a magnesium ion (Mg²⁺), an aluminum ion (Al³), a silver ion (Ag⁺), a fluoride ion (F⁻), or a chloride ion (Cl⁻) is insertable into and extractable from. The negative electrode active material included in the negative electrode 30 includes, for example, at least one selected from the group consisting of, for example: an oxide including at least one element selected from the group consisting of Ti, Si, Sn, Cr, Fe, Nb, and Mo; a graphite-lithium compound; a lithium alloy; a lithium-containing phosphoric acid compound having a NASICON structure; a lithium-containing phosphoric acid compound having an olivine structure; and a lithium-containing oxide having a spinel structure. Examples of the lithium alloy include Li—Al. Examples of the lithium-containing phosphoric acid compound having the NASICON structure include Li₃V₂(PO₄)₃ and LiTi₂(PO₄)₃. Examples of the lithium-containing phosphoric acid compound having the olivine structure include Li₃Fe₂(PO₄)₃ and LiCuPO₄. Examples of the lithium-containing oxide having the spinel structure include Li₄Ti₅O₁₂.

The negative electrode active material which a sodium ion is insertable into and extractable from includes, for example, at least one selected from the group consisting of, for example, a sodium-containing phosphoric acid compound having a NASICON structure, a sodium-containing phosphoric acid compound having an olivine structure, and a sodium-containing oxide having a spinel structure.

### <2.2 Method of Manufacturing Solid-State Battery 100>

A description is given of an example of a method of manufacturing the solid-state battery 100. The solid-state battery 100 may be manufactured by a printing method such as a screen printing method, a green sheet method in which a green sheet is used, or a combined method thereof. One manufacturing method is described below as an example; however, the disclosure is not limited to the following manufacturing method. Temporal matters such as the order of descriptions below are merely for description convenience, and the disclosure is not limited thereto.

First, the positive electrode 10 is fabricated. Specifically, a plurality of positive electrode active material particles 12P having a predetermined median diameter is prepared. The positive electrode active material particles 12P may each be coated with an ion conductive material such as LiNbO₃ using a tumbling fluidized bed coater. Thereafter, the positive electrode active material particles 12P and the solid-state electrolyte material SE are kneaded at a predetermined volume ratio (e.g., 5:5) to thereby prepare a positive electrode active material mixture. Thereafter, the positive electrode current collector 11 is prepared, and the positive electrode active material mixture is applied onto a surface of the positive electrode current collector 11, following which the resultant is press-molded using a pressing machine to obtain the positive electrode active material layer 12. The positive electrode 10 is thus obtained.

Thereafter, the negative electrode 30 is fabricated. Specifically, negative electrode active material particles and the solid-state electrolyte material SE are kneaded at a predetermined volume ratio (e.g., 5:5) to thereby prepare a negative electrode active material mixture. Thereafter, the negative electrode current collector 31 is prepared, and the negative electrode active material mixture described above is applied onto a surface of the negative electrode current collector 31. Thereafter, the negative electrode active material mixture applied onto the negative electrode current collector 31 is press-molded using the pressing machine to thereby form the negative electrode active material layer 32 on the negative electrode current collector 31. The negative electrode 30 is thus obtained.

Lastly, the positive electrode 10, the solid-state electrolyte layer 20, and the negative electrode 30 are stacked in order to fabricate a stacked body, following which the stacked body is compressed using the pressing machine. The solid-state battery 100 is thus fabricated.

### <2.3 Action and Effects of Solid-State Battery 100>

The solid-state battery 100 according to the present embodiment includes the solid-state electrolyte material SE described in the first embodiment above. Therefore, it is possible to achieve superior performance. For example, it is possible to achieve both superior ion conductivity and superior processability. Further, the covering part 2 is provided on the surface of the solid-state electrolyte particle 1. This prevents, for example, contact between the positive electrode active material and the solid-state electrolyte particle 1 in the positive electrode 10, and thus makes it possible to avoid decomposition of the sulfide solid-state electrolyte included in the solid-state electrolyte particle 1. Accordingly, the solid-state battery 100 according to the present embodiment makes it possible to achieve higher reliability.

### 3. EXAMPLES

A description is given of Examples of the disclosure.

### Example 1

As described below, the solid-state battery of the disclosure illustrated in FIG. 2 was fabricated, following which a battery characteristic of the solid-state battery was evaluated.

### <Fabrication of Positive Electrode>

First, an aluminum (Al) foil having a thickness of 12 m was prepared as the positive electrode current collector. Thereafter, particles of lithium cobalt oxide (LCO) having a median diameter D50 of 7 μm were prepared as the positive electrode active material particles. Thereafter, particles of Li₆PS₅Cl having a median diameter D50 of 0.3 m as the solid-state electrolyte particles having the predetermined median diameter were put into an electric furnace, and a nitrogen (N₂) gas or an argon (Ar) gas controlled to have a dew point within a range from −60° C. to −40° C. both inclusive was injected into the electric furnace for one hour. Thereafter, the solid-state electrolyte particles were heated at temperature of 150° C. for one hour in the atmosphere of the nitrogen (N₂) gas or the argon (Ar) gas. The covering part including Li₂OHCl was thus formed on the surface of each of the solid-state electrolyte particles to obtain the solid-state electrolyte material. Thereafter, the above-described positive electrode active material particles and the above-described solid-state electrolyte material were kneaded at a volume ratio of 5:5 to thereby prepare the positive electrode active material mixture. Thereafter, the positive electrode active material mixture was applied onto the surface of the positive electrode current collector, following which the resultant was press-molded using a pressing machine at a pressure of 98 MPa to form the positive electrode active material layer. The positive electrode was thus obtained. Note that in the present Example, the positive electrode active material layer had a thickness of 60 m.

### <Fabrication of Negative Electrode>

A copper (Cu) foil having a thickness of 12 m was prepared as the negative electrode current collector. Thereafter, particles of graphite having a median diameter D50 of 12 m were prepared as the negative electrode active material particles. Thereafter, the negative electrode active material particles and the solid-state electrolyte material were kneaded at a volume ratio of 5:5 to thereby prepare a negative electrode active material mixture. The solid-state electrolyte material was the same as the solid-state electrolyte material used in the fabrication of the positive electrode, i.e., the solid-state electrolyte material including Li₆PS₅Cl as the solid-state electrolyte particle and Li₂OHCl as the covering part. Thereafter, the negative electrode active material mixture was applied onto the surface of the negative electrode current collector, following which the resultant was press-molded using a pressing machine at a pressure of 98 MPa to form the negative electrode active material layer. The negative electrode was thus obtained. Note that in the present Example, the negative electrode active material layer had a thickness of 55 μm.

### <Fabrication of Solid-State Positive Electrode Half Cell>

A solid-state electrolyte layer was bonded to the positive electrode obtained as described above. The solid-state electrolyte layer was also referred to as a separator, and included the solid-state electrolyte material that was the same as the solid-state electrolyte material used in the fabrication of the positive electrode, i.e., the solid-state electrolyte material including Li₆PS₅Cl as the solid-state electrolyte particle and Li₂OHCl as the covering part. Thereafter, the resultant was pressure-molded using a pressing machine at 98 MPa and then at 588 MPa. Thus, a stacked body including the positive electrode and the solid-state electrolyte layer was formed. In addition, an electrode including a Li—In alloy having a composition mole ratio of 1:1 was stacked on an opposite side of the solid-state electrolyte layer to the positive electrode, and the resultant was pressure-molded. A solid-state positive electrode half cell was thus obtained.

### <Fabrication of Solid-State Negative Electrode Half Cell>

A solid-state electrolyte layer was bonded to the negative electrode obtained as described above. The solid-state electrolyte layer included the solid-state electrolyte material that was the same as the solid-state electrolyte material used in the fabrication of the negative electrode, i.e., the solid-state electrolyte material including Li₆PS₅Cl as the solid-state electrolyte particle and Li₂OHCl as the covering part. Thereafter, the resultant was pressure-molded using a pressing machine at 98 MPa and then at 588 MPa. Thus, a stacked body including the negative electrode and the solid-state electrolyte layer was formed. In addition, as with the above-described solid-state positive electrode half cell, an electrode including a Li—In alloy having a composition mole ratio of 1:1 was stacked on an opposite side of the solid-state electrolyte layer to the negative electrode, and the resultant was pressure-molded. A solid-state negative electrode half cell was thus obtained.

### <Battery Characteristic Evaluation>

Evaluation of the fabricated solid-state battery of Example 1 for its battery characteristic revealed the result presented in Table 1. Here, the solid-state battery of Example 1 was discharged at a rate of 0.5 C in a room temperature environment. A positive electrode discharge capacity [mAh/g] and a negative electrode discharge capacity [mAh/g] at that timing were each measured. Note that 1 C was a value of a current calculated by multiplying a mass [g] of an active material introduced as an electrode of the solid-state battery by a theoretical capacity [mAh/g]. Further, an ion conductivity [mS/cm] of the solid-state battery of Example 1 and an amount of generated hydrogen sulfide (H₂S) at a humidity of 70% were each measured. Note that details of test conditions were as described below.

### <Discharge Capacity>

Positive electrode: A discharge capacity of the solid-state positive electrode half cell was obtained as follows. Where 1 C was defined based on a LCO theoretical capacity of 150 mAh/g, the solid-state positive electrode half cell was charged at 0.1 C until a voltage became 3.63 V (4.25 V versus a lithium reference electrode, i.e., vs Li⁺/Li), and was thereafter discharged at 0.5 C until the voltage became 2.38 V (3.0 V versus a lithium reference electrode, i.e., vs Li⁺/Li). The discharge capacity at this timing was obtained.

Negative electrode: A discharge capacity of the solid-state negative electrode half cell was obtained as follows. Where 1 C was defined based on a graphite theoretical capacity of 372 mAh/g, the solid-state negative electrode half cell was charged at 0.1 C until a voltage became −0.57 V (0.05 V versus a lithium reference electrode, i.e., vs Li⁺/Li), and was thereafter discharged at 0.5 C until the voltage became 0.88 V (1.5 V versus a lithium reference electrode, i.e., vs Li⁺/Li). The discharge capacity at this timing was obtained.

### <Ion Conductivity>

A hundred milligrams of each of the solid-state electrolytes was pressed by a zirconia insulating cylinder of 10 mmφ at 294 MPa in a room temperature environment, and was thereafter subjected to electrochemical impedance spectrum measurement at an amplitude of 10 mV and a frequency within a range from 10⁶ Hz to 10 Hz both inclusive in an environment of 23° C. while pressure was kept at 98 MPa. An ion conductivity [mS/cm] was calculated based on a resistance value obtained from the measured spectrum and an actually measured value of a thickness of the pellet.

### <Measurement of Hydrogen Sulfide Generation Amount>

A wet-air atmosphere at 23° C. and a relative humidity of 70% was prepared in a container having a volume of 2 L. 300 mg of each of the solid-state electrolytes and a hydrogen sulfide concentration meter were put together in the container. A cumulative amount [cc/g] of hydrogen sulfide generated in one hour was obtained.

TABLE 1

| | | | | | Discharge | |
|---|---|---|---|---|---|---|
| | | | | H₂S | capacity | |
| | Solid-state | | Ion | generation | [mAh/g] | |
| | electrolyte | covering | conductivity | amount | Positive | Negative |
| | particles | part | [mS/cm⁻¹] | [cc/g] | electrode | electrode |
| Example 1 | Li₆PS₅Cl | Li₂OHCl | 2.1 | 10 | 120 | 330 |
| Comparative | Li₆PS₅Cl | N/A | 2.0 | 50 | 30 | 325 |
| example 1 | | | | | | |
| Example 2 | Li₆PS₅Cl_{0.5}Br_{0.5} | Li₂OH(Cl,Br) | 2.2 | 11 | 122 | 330 |
| Comparative | Li₆PS₅Cl_{0.5}Br_{0.5} | N/A | 2.1 | 52 | 31 | 328 |
| example 2 | | | | | | |
| Example 3 | Li₄SnS₄ | Li₂OHI | 0.12 | 1.1 | 115 | 230 |
| Comparative | Li₄SnS₄ | N/A | 0.10 | 2.0 | 45 | 200 |
| example 3 | | | | | | |
| Example 4 | Li_{4.5}SnS₄I_{0.5} | Li₂OHI | 0.28 | 0.8 | 98 | 255 |
| Comparative | Li_{4.5}SnS₄I_{0.5} | N/A | 0.25 | 1.5 | 20 | 215 |
| example 4 | | | | | | |

### Example 2

As indicated in Table 1, a solid-state battery of Example 2 was fabricated by a procedure similar to that of Example 1, except that Li₆PS₅Cl_{0.5}Br_{0.5} was used as the solid-state electrolyte particles and the covering part including Li₂OH(Cl, Br) was formed. Thereafter, a battery characteristic of the solid-state battery of Example 2 was evaluated by a procedure similar to that of Example 1. The results of the evaluation are also presented in Table 1.

### Example 3

As indicated in Table 1, a solid-state battery of Example 3 was fabricated by a procedure similar to that of Example 1, except that Li₄SnS₄ was used as the solid-state electrolyte particles and the covering part including Li₂OHI was formed. Thereafter, a battery characteristic of the solid-state battery of Example 3 was evaluated by a procedure similar to that of Example 1. The results of the evaluation are also presented in Table 1.

### Example 4

As indicated in Table 1, a solid-state battery of Example 4 was fabricated by a procedure similar to that of Example 1, except that Li_{4.5}SnS₄I_{0.5} was used as the solid-state electrolyte particles and the covering part including Li₂OHI was formed. Thereafter, a battery characteristic of the solid-state battery of Example 4 was evaluated by a procedure similar to that of Example 1. The results of the evaluation are also presented in Table 1.

### Comparative Examples 1 to 4

As indicated in Table 1, each of solid-state batteries of Comparative examples 1 to 4 was fabricated by a procedure similar to that of Example 1, except that no covering part was formed on each of the solid-state electrolyte particles. Thereafter, a battery characteristic of each of the solid-state batteries of Comparative examples 1 to 4 was evaluated by a procedure similar to that of Example 1. The results of the evaluation are also presented in Table 1.

### Discussion

Referring to Table 1, as is apparent from comparison between Example 1 and Comparative example 1, comparison between Example 2 and Comparative example 2, comparison between Example 3 and Comparative example 3, and comparison between Example 4 and Comparative example 4, it was confirmed that providing the covering part on each of the solid-state electrolyte particles resulted in high values for all of the ion conductivity, the positive electrode discharge capacity, and the negative electrode discharge capacity. It was also confirmed that providing the covering part on the solid-state electrolyte particle made it possible to greatly reduce the amount of generated hydrogen sulfide. It was thus confirmed that the use of the solid-state electrolyte material of the present disclosure made it possible to protect the solid-state electrolyte particles from, for example, air or moisture by the covering part, without decreasing the ion conductivity, and thus made it possible to improve environmental tolerance of the solid-state electrolyte particles.

Although the disclosure has been described above with reference to some embodiments and Examples, the configuration of the disclosure is not limited to those described above, and is therefore modifiable in a variety of ways.

Specifically, for example, the second embodiment has been described above referring to the case where both the positive electrode active material layer 12 and the negative electrode active material layer 32 include the solid-state electrolyte material SE; however, the disclosure is not limited thereto. For example, only either of the positive electrode active material layer 12 or the negative electrode active material layer 32 may include the solid-state electrolyte material SE.

The effects described herein are mere examples, and effects of the disclosure are not limited to those described herein. Accordingly, the disclosure may achieve any other effect.

1. A solid-state electrolyte material comprising:
a solid-state electrolyte particle; and
a covering part on a surface of the solid-state electrolyte particle, the covering part including Li₂₊ₓ(OH)₁₋ₓY, where 0≤x<1, and Y is chlorine, bromine, or iodine.

2. The solid-state electrolyte material according to claim 1, wherein the covering part covers an entirety of the surface of the solid-state electrolyte particle.

3. The solid-state electrolyte material according to claim 1, wherein the covering part covers at least a part of the surface of the solid-state electrolyte particle.

4. The solid-state electrolyte material according to claim 1, wherein the solid-state electrolyte particle includes a sulfide.

5. The solid-state electrolyte material according to claim 1, wherein the solid-state electrolyte particle includes lithium (Li) and sulfur (S).

6. The solid-state electrolyte material according to claim 5, wherein the solid-state electrolyte particle further includes a halogen element.

7. The solid-state electrolyte material according to claim 1, wherein the solid-state electrolyte particle includes Li₆PS₅Cl, Li₆PS₅Cl_{0.5}Br_{0.5}, Li₄SnS₄, or Li_{4.5}SnS₄I_{0.5}.

8. The solid-state electrolyte material according to claim 1, wherein
the solid-state electrolyte particle has a median diameter of 0.1 micrometers to 20 micrometers, and
the covering part has a thickness of 1 nanometer to 1000 nanometers.

9. The solid-state electrolyte material according to claim 1, wherein the solid-state electrolyte particle has a median diameter of 0.1 micrometers to 20 micrometers.

10. The solid-state electrolyte material according to claim 1, wherein the covering part has a thickness of 1 nanometer to 1000 nanometers.

11. A solid-state battery comprising:
a positive electrode;
a negative electrode; and
a solid-state electrolyte layer including the solid-state electrolyte material according to claim 1 between the positive electrode and the negative electrode.

12. The solid-state battery according to claim 11, wherein the positive electrode, the negative electrode, or both include the solid-state electrolyte material.

13. An electrode comprising:
a solid-state electrolyte particle;
a covering part on a surface of the solid-state electrolyte particle, the covering part including Li₂₊ₓ(OH)₁₋ₓY, where 0≤x<1, and Y is chlorine, bromine, or iodine; and
an active-material constituent in contact with the covering part.

14. The electrode according to claim 13, wherein the solid-state electrolyte particle includes a sulfide.

15. The electrode according to claim 13, wherein the solid-state electrolyte particle includes lithium (Li) and sulfur (S).

16. The electrode according to claim 15, wherein the solid-state electrolyte particle further includes a halogen element.

17. The electrode according to claim 13, wherein the solid-state electrolyte particle includes Li₆PS₅Cl, Li₆PS₅Cl_{0.5}Br_{0.5}, Li₄SnS₄, or Li_{4.5}SnS₄I_{0.5}.

18. The electrode according to claim 13, wherein
the solid-state electrolyte particle has a median diameter of 0.1 micrometers to 20 micrometers, and
the covering part has a thickness of 1 nanometer to 1000 nanometers.

19. A solid-state battery comprising:
a positive electrode;
a negative electrode; and
a solid-state electrolyte layer between the positive electrode and the negative electrode,
wherein at least one of the positive electrode or the negative electrode include the solid-state electrolyte material according to claim 1.
